(19) United States
(12) Patent Application Publication
(10) Pub. No.: US 2015/0278781 A1
(43) Pub. Date: Oct. 1, 2015

(54) API ENGINE FOR A SELF-SERVICE DEVICE

(71) Applicant: Diebold Self-Service Systems Division of Diebold, Incorporated, North Canton, OH (US)

(72) Inventors: Shelly R. Ewing, Akron, OH (US); Richard Harris, Warash Southhampton (GB); Devon Watson, Canal Fulton, OH (US)

(21) Appl. No.: 14/669,650

(22) Filed: Mar. 26, 2015

Related U.S. Application Data
(60) Provisional application No. 61/972,557, filed on Mar. 31, 2014.

(51) Int. Cl. G06Q 20/10; G06F 9/54

(52) U.S. Cl. CPC G06Q 20/108; G06F 9/541

(57) ABSTRACT

In an example embodiment described herein is an application program interface (API) suitable to couple a self service device, such as an automated banking machine, with various banking services. The API acts as a repository or requestor of information from many different sources such as, for example, a financial core, a transaction switch/processor, third party partners such as check guarantee service providers, customer information files stored and maintained by a financial institution or data obtained from other channels such as core banking, Customer Relationship Management (CRM), mobile banking and/or online banking platforms.

### CROSS REFERENCE TO RELATED APPLICATIONS

This application claims the benefit under 35 U.S.C. §119 of U.S. Provisional Application No. 61/962,557, filed Mar. 31, 2014. U.S. Provisional Application No. 61/962,557 is incorporated by reference herein in its entirety.

### TECHNICAL FIELD

The present disclosure relates generally to an application program interface (API) engine for use with self service devices such as an automated banking machine.

### BACKGROUND

A common type of self service automated banking machine used by consumers is an automated teller machine (ATM) which enables customers to carry out banking transactions. Banking transactions carried out may include the dispensing of cash, the making of deposits, and/or the transfer of funds between accounts and account balance inquiries. The types of banking transactions a consumer can carry out are determined by the capabilities of the particular banking machine.

### BRIEF DESCRIPTION OF THE DRAWINGS

The accompanying drawings incorporated herein and forming a part of the specification illustrate the example embodiments.

FIG. 1 is a block diagram illustrating an example of an automated banking machine coupled with a server employing an application programming interface for providing financial services.

FIG. 2 is a block diagram illustrating a detailed view of the self-service device coupled with an API engine.

FIG. 3 is a block diagram of a computer system upon which an example embodiment can be implemented.

FIG. 4 is a block diagram of a methodology for employing an application programming interface for providing banking services.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In an example embodiment, there is disclosed herein, an apparatus that comprises application program interface (API) logic communicatively coupled with a self service device, such as, for example, a self service banking device, an automated teller machine (“ATM”), an in-lobby terminal, or an alternative access point to a financial network, and with a plurality of financial institution data stores. The application program interface logic is operable to handle transaction requests for the self service device. For example, the application program interface logic is operable to selectively route a first transaction request to a first financial data store responsive to determining the first transaction request corresponds to a first type of transaction. The application program interface logic is operable to selectively redirect a second transaction request to a second a second financial data store responsive to determining the second transaction requests corresponds to a second type of transaction.

In an example embodiment, there is disclosed herein, logic encoded in a non-transitory, tangible computer readable medium of execution for execution by a processor, and when executed operable to receive transaction requests from a self service device. The logic is operable to determine a transaction type for individual transaction requests. The logic is further operable to selectively route a first transaction request to a first financial data store responsive to determining the first transaction request corresponds to a first type of transaction. The logic is operable to selectively re-format and route a second transaction request to a second destination responsive to determining the second of transaction request corresponds to a second type of transaction.

In accordance with an example embodiment, there is disclosed herein, a method that routes transaction requests to financial data stores based on the type of transaction. For example, a first transaction request is forwarded to a first financial data store responsive to determining the first transaction request corresponds to a first type of transaction. A second transaction request is routed to a second financial data store responsive to determining the second requests correspond to a second type of transaction.

### Description of Example Embodiments

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

In an example embodiment, there is described herein a server based solution which provides an application program interface (API) for providing access to various types of data. A server based engine and API library can act as a repository and/or requestor of information from many different sources such as a financial core, transaction switch/processor, third party partners, such as, for example, check guarantee service providers, customer information files stored and maintained by a financial institution, and/or other channels such as core banking, customer relationship management (CRM), mobile, teller, and/or online banking platform. In an example embodiment, the API can push/pull data from sources other than the automated banking machine's switch. The API can correlate data from multiple sources and translate the data into consumable information for a consumer.

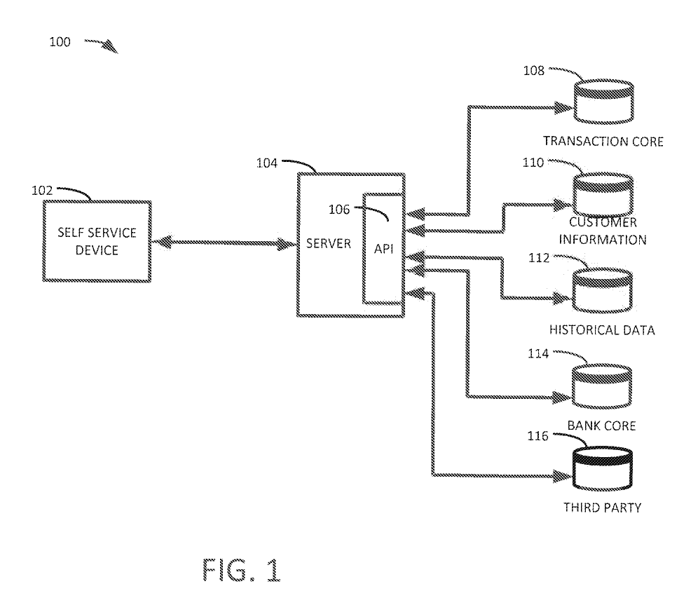

FIG. 1 is a block diagram illustrating an example of system 100 where a self service device, such as an automated banking machine, e.g., an automated teller machine (ATM) in the illustrated example, 102 is coupled with a server 104 employing an application programming interface (API) logic 106 for providing financial services. The API 106 is coupled to financial data stores, such as for example a transaction core 108, a customer information database 110, a historical data database 112, a bank core database 114, and a third party service 116.

As illustrated, the API logic 106 has separate connections to the self-service device 102, transaction core 108, customer information database 110, historical data database 112, bank core data base 114, and third party service 116, however, those skilled in the art should readily appreciate that the connections are illustrated merely for ease of illustration as one or more of the transaction core 108, customer information database 110, historical data database 112, bank core data base 114, and/or third party service 116 may be coupled with the same physical network (e.g., an Intranet or Internet) which may optionally employ virtual private networks (VPNs) or a combination of networks may be employed to couple the transaction core 108, customer information database 110, historical data database 112, bank core data base 114, and/or third party service 116 with the API logic 106. In particular embodiments, the financial data stores, such as the transaction core 108, customer information database 110, historical data database 112, bank core data base 114, third party service 116, and/or any combination of the aforementioned financial data stores may be embodied on one or more servers (or hosts). Thus, the example embodiments described herein should not be considered to be limited as illustrated.

In an example embodiment, the self-service device 102 is configured with states and screens for predefined transactions. For example, the self-service device 102 may be configured with states and screens for Personal Financial Management (PFM) transactions, origination (for example loan origination) transactions, financial transactions (e.g., deposits and withdrawals) and other types of transactions. The API logic 106 is configured a pre-built library of API hooks specifying the type and format of data that can be pushed or pulled from the server 104. Thus, the API logic 106 can act as a “universal translator” for the self-service device 102. In another example embodiment, the self service device 102 is a thin client, and the screens and menus for the self service device 104 is provided by the server 104.

In an example embodiment, the server 104 receives transaction requests from self-service device 102. The transaction requests are forwarded to API 106 logic for processing. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software that performs the described functionality when executed by a processor.

In an example embodiment, the API logic 106 determines the type of transaction being requested and how the transaction request should be handled. This may include where to route the transaction, reformatting the request to be compatible with the financial data store, or stores, that will be handling the request and/or generating a request to the appropriate financial data store. For example, the API logic 106 is operable to route a first transaction request that is a first type of request for a financial transaction (e.g., a transaction that is routed through the self-service device switch for processing by a transaction processor associated with the transaction core 108), for example a cash withdrawal from the self-service device 102 or a deposit being made at the self-service device 102, the API logic 106 to forward the request to the transaction core 108 unchanged. If a second transaction request that is a second type of transaction request (e.g., a transaction that is not routed through the self-service device switch to a transaction processor via the transaction core 108) is received, the API logic 106 is operable to determine the type of transaction, and redirect the second transaction request to the appropriate data store (e.g., to the customer information database 110, historical database 112, bank core 114, and/or third party service 116). Optionally, the API logic 106 may determine the appropriate format for the second transaction request and format the request accordingly.

The API logic 106 also routes responses received for transaction requests to the self service device 102. Optionally, the response may be reformatted to be compatible with the self service device 102. For example, a response for the first type (e.g., a financial transaction) can be forwarded by the API logic 106 to the self-service device 102 unchanged. However, for responses for the second type of transaction (e.g., the second transaction described herein supra), the API logic 106 determines the appropriate format for the response to the second transaction request for the self-service device 102. For example, the API logic 106 will determine an appropriate data format that comports with the screen that self-service device 102 will use to display the response. The API logic 106 is operable to route the response for the second transaction request to a predefined format for the self-service device 102 and forward the reformatted response to the to the self service device 112.

Although the illustrated example shows a single self-service device 112 coupled with server 104, those skilled in the art should readily appreciate that a plurality of self-service devices 112 can be coupled to server 104. The API logic 106 is operable to receive transaction requests from the plurality of self service devices. In particular embodiments, the API logic 106 is operable to maintain a plurality of libraries corresponding to the plurality of self service devices 112 coupled with the server 104. Moreover, in an example embodiment, the API logic 106 may be embodied on a plurality of servers 104.

In an example embodiment, if the API logic 106 receives a transaction request from self-service device 102 that is not a predefined transaction type, API logic 106 will reject the request. Optionally, the API logic 106 may send a message to self-service device 112 indicating that the transaction request was rejected. This can prevent the self-service device 112 from carrying out an unauthorized transaction. For example, if self-service device 112 is configured with a screen that does not have a corresponding entry in API logic's 106 library, the transaction request will be blocked by the API logic 106.

In an example embodiment, the API logic 106 may route a transaction request to a plurality of destinations, which may also employ different data formats. Responses can be correlated and provided to the requestor. For example, if a consumer at the self-service device 112 requests historical data (e.g., checking activity for the last 6 months), the API logic 106 may generate a request to obtain checking account data for the customer and send the request to the customer information database 110 to obtain checking account information. The API logic 106 can employ the checking account information obtained from the customer information database 110 generate a query to the historical database 112. Responses from the customer information database 110 and historical database 112 may be correlated and converted to a format suitable for the self-service device 112, and forwarded to the self-service device 112.

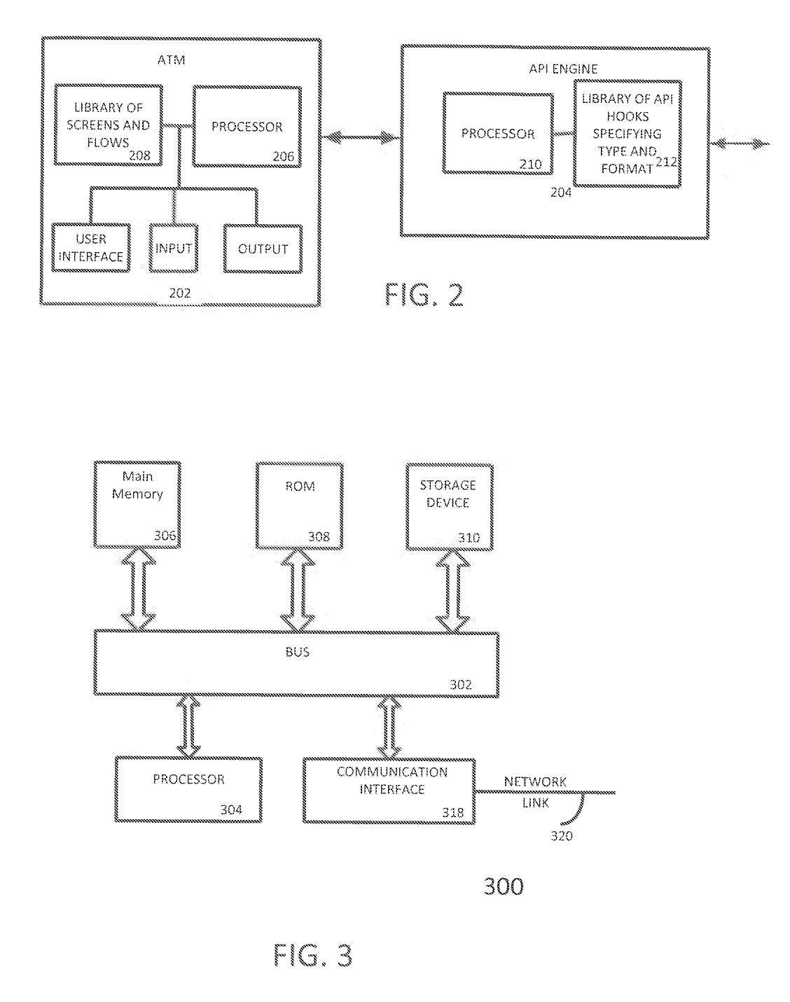

FIG. 2 is a block diagram illustrating a detailed view of the self service device 202 coupled with an API engine 204. Self service device 202 is suitable for implementing the functionality of self service device 102 in FIG. 1. API engine 204 is suitable for implementing the API logic 106 of FIG. 1.

In the illustrated example, the self-service device 202 comprises a processor 206, a library of screens and flows 208, a user interface 214, an input device 216, and an output device 218. The user interface 214 may suitably comprise any one or more devices for obtaining an input from a consumer to conduct a transaction such as a card reader, display, and keypad, wireless reader, touch screen, etc. The input device 216 may suitably comprise one or more devices capable of receiving items from a consumer such as a depository which may include check reader and/or cash acceptor. The output device 218 may be any one or more device for providing items to a consumer such as a cash dispenser, check dispenser, receipt printer. Moreover, other devices may be coupled to both the input device 216 and the output device 218 such as a cash recycler.

The API Engine 204 comprises a processor 210 and a library of API hooks 212 that specify types and formats of data that can be pushed or pulled from various financial data stores. In an example embodiment, the API hooks in the library of API hooks 212 correspond to the screens and flows stored in the library of screens in flows 208 in the self-service device 202.

In an example embodiment, the processor 206 in self-service device 202 is operable to generate screens obtained from the library of screens and flows 208 and output the screens on the self-service device's user interface 214. In an alternate embodiment where the self service device 202 is a thin client, the library of screens and flows may be located at the API engine 204. When a consumer selects a transaction, the transaction request is forward by processor 206 to processor 210 of the API engine 204. In some embodiments, the processor 210 determines from the library of API hooks 212 the appropriate format for the transaction request and converts the request accordingly. The library of API hooks 212 may optionally include a destination address for the transaction request. For example, the processor 210 may convert a first type of transaction request to a first format, and a second type of transaction request to a second format. The processor 210 then redirects the converted request to the appropriate destination.

Similarly, when the processor 210 receives a response to the transaction request, the processor 210 obtains from the library of API hooks 212 data indicating to determine whether the response should be translated for the self-service device 202. For example, the processor 210 can format the response to match the screen that self-service device 202 will be employing the output the response.

In an example embodiment, processor 210 is coupled with a transaction processor. Since the self-service device 202 can provide transaction requests that are compatible with the transaction processor, transaction requests to the transaction processor can be forwarded to the transaction processor unchanged.

Although the example illustrated in FIG. 2 illustrates a single self-service device 202 coupled with API engine 204, those skilled in the art can readily appreciate that multiple self-service devices 202 can be coupled with API engine 204. Thus, the principles set forth herein should not be construed as limited to embodiments where a single self-service device 202 is coupled to an API engine 204. The API engine 204 may receive a plurality of requests from a plurality of self-service devices 212.

In an example embodiment, if the self-service device 202 sends a transaction request to the API engine 204 that is not defined in the in the library of API hooks 204, the transaction request is rejected. Optionally, a message may be sent to the self-service device 202 indicating the transaction request is unavailable from the self-service device 202 sending the transaction request.

In an example embodiment, the API engine 204 may receive a transaction request from the self-service device 202 that requires a response from a plurality of destinations. For example, a consumer may request historical account data which can entail obtaining account information for the consumer from a first data source and using the account information to obtain the historical data for one or more accounts. The processor 210 may route the transaction to a plurality of requests for a plurality of financial data stores for the transaction, which may be based on the type of transaction. In an alternate embodiment, the processor 210 may generate requests and them to the plurality of financial data stores. The processor 210 forwards the plurality of routeted requests to the plurality of destinations. The processor 210 receives responses from the plurality of destinations. The processor 210 correlates the responses from the plurality of destinations. The processor 210 routes the correlated responses from the plurality of destinations to a predefined format obtained from the library of API hooks 212 for the appropriate screen defined in the library of screens and flows 208 in self-service device 202. The processor 210 forwards the routeted, correlated responses from the plurality of destinations for the second transaction type to the self service device.

FIG. 3 is a block diagram of a computer system 300 upon which an example embodiment can be implemented. Computer system 300 is suitable for implementing the logic of the self-service device 102 (FIG. 2), API 106 (FIG. 1, self-service device 202 (FIG. 2), and/or API Engine 204 (FIG. 2).

Computer system 300 includes a bus 302 or other communication mechanism for communicating information and a processor 304 coupled with bus 302 for processing information. Computer system 300 also includes a main memory 306, such as random access memory (RAM) or other dynamic storage device coupled to bus 302 for storing information and instructions to be executed by processor 304. Main memory 306 also may be used for storing a temporary variable or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

An aspect of the example embodiment is related to the use of computer system 300 for implementing an application program interface for an automated banking machine. According to an example embodiment, implementing an application program interface for an automated banking machine is provided by computer system 300 in response to processor 304 executing one or more sequences of one or more instructions contained in main memory 306. Such instructions may be read into main memory 306 from another computer-readable medium, such as storage device 310. Execution of the sequence of instructions contained in main memory 306 causes processor 304 to perform the process steps described herein. One or more processors in a multi-processing arrangement may also be employed to execute the sequences of instructions contained in main memory 306. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 304 for execution. Such a medium may take many forms, such as volatile media. Non-volatile media includes for example optical or magnetic disks, such as storage device 310. Common forms of computer-readable media include for example floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

Computer system 300 also includes a communication interface 318 coupled to bus 302. Communication interface 318 provides a two-way data communication coupling computer system 300 to a network link 320 that is connected to facilitate communication with external devices. For example, communication interface 318 may be a local area network (LAN) card to provide a data communication connection to a compatible LAN. As another example, communication interface 318 may be an integrated services digital network (ISDN) card or a modem to provide a data communication connection to a corresponding type of telephone line. Wireless links may also be implemented. In any such implementation, communication interface 318 sends and receives electrical, electromagnetic, or optical signals that carry digital data streams representing various types of information.

In particular embodiments, computer system 300 may include a plurality of communication interfaces 318 for communicating with a plurality of remote devices. For example, a first communication interface may be employed to communicate with a self service device while a second communication interface may be employed to communicate with the transaction core, customer information data, historical data, bank core data, and/or third party data. As another example, a first interface may be employed to communicate with an automated banking machine, a second interface for communicating with a transaction core, and one or more additional communication interfaces for communicating with customer information data, historical data, bank core data, and/or third party data.

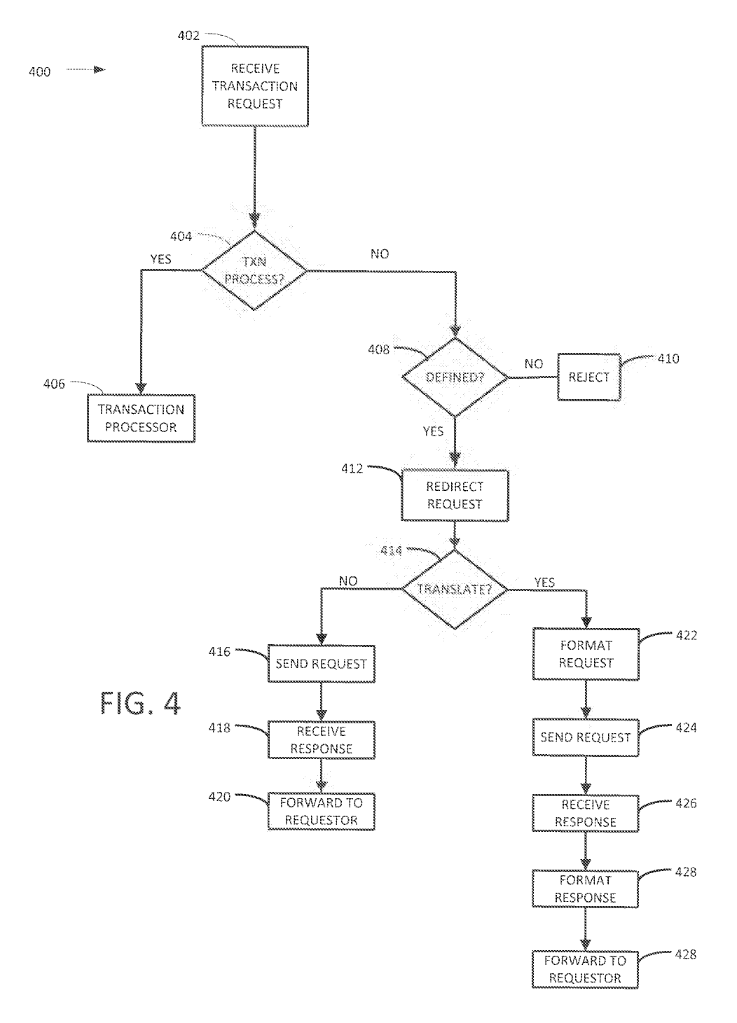

In view of the foregoing structural and functional features described above, a methodology 400 in accordance with an example embodiment will be better appreciated with reference to FIG. 400. While, for the purpose of simplicity of explanation the methodology of FIG.4 is shown and described as executing serially, it is to be understood and appreciated that the example embodiment is not limited by the illustrated order, as some aspects could occur in different orders and/or concurrently with other aspects from that shown and described herein. Moreover, not all illustrated features may be required to implement a methodology in accordance with an aspect of an example embodiment. The methodology 400 described herein is suitably adapted to be implemented in hardware, software when executed by a processor, or a combination thereof. For example, methodology 400 may be performed by API logic 106 (FIG. 1), processor 210 (FIG. 2), and/or processor 304 (FIG. 3).

At 402, a financial transaction request is received from an automated banking machine, such as a self-service device. At 404, the type of transaction is determined. If the transaction request is for a financial transaction handled by a transaction processor (YES), at 406 the transaction is forwarded to the transaction processor. In particular embodiments, 404 can be skipped and the method 400 would continue at 406.

If, at 404, a determination is made that the transaction request is for a financial transaction that is not handled by a transaction processor (NO), at 406, a library of API hooks is searched for the transaction type. If an API hook cannot be found for the type of transaction being requested (NO), the transaction request is rejected at 408. Optionally, a response may be sent to the requesting self-service device indicating that the type of transaction requested is unavailable.

If, at 406, the an API hook is found for the type of transaction being requested in the transaction request (YES), at 410 the transaction request is redirected to the most appropriate financial data store for the type of transaction. In particular embodiments, if the transaction request is serviced by multiple data stores, the copies of the transaction request can be sent to the multiple financial data stores, or in some embodiments, multiple requests that are properly formatted for their respective destinations are generated.

At 412, the request, is redirected to the appropriate financial data store. If the transaction request is serviced by multiple destinations, multiple requests are directed to their respective financial data stores.

In particular embodiments, at 414 a determination is made whether the request should be translated or reformatted for the financial data store that will be handling the request. If no translation or formatting is needed (NO), at 416 the request is sent to the financial data store. At 418, a response to the request is received that is forwarded to the requestor at 420.

However, if at 414, the determination is made that the request should be converted or reformatted (YES), at 422 the request is converted to a format appropriate for the financial data store that will be handling the transaction. At 424, the request is sent to the financial data store.

At 426, a response to the transaction request is received. If needed, the response is converted to an appropriate format for the requestor at 428. At 428, the response, or converted response, is forwarded to the requestor.

The following example illustrates how method 400 operates. The example employs four transaction requests, a first transaction request for a first type of transaction and a second transaction request for a second transaction, a third transaction for a third type of transaction, and a fourth transaction for a fourth type of transaction. The transaction requests may be received in any order. The first transaction request is for a transaction that is to be handled by the transaction processor. The second transaction type is for a transaction that is not being handled by the transaction processor and is not to be converted or translated. The third type of transaction is for a transaction that is not to be handled by the transaction processor and is to be converted. The fourth type of transaction is an unknown type of transaction.

The first transaction request is received at 402. At 404, the determination is made whether the first transaction should be handled by a transaction processor based on the type of transaction being requested. For this example, the first transaction is to be handled by the transaction processor (YES), so at 406 the transaction is forwarded to the transaction processor.

The second transaction request is received at 402. At 404, the determination is made that the second transaction request is for a type of transaction that is not handled by the transaction processor (NO). At 408, a determination is made that the second transaction is defined (YES) so the transaction is redirected at 412.

At 414, the determination is made that the second transaction request is not being converted or translated (NO), so at 416 the second transaction request is sent to the appropriate financial data store. At 418, a response to the second transaction request is received, and at 420, the response is forwarded to the requestor (e.g., the self service device such as an ATM that sent the request).

The third transaction request is received at 402. At 404, the determination is made that the third transaction request is for a type of transaction that is not handled by the transaction processor (NO). At 408, a determination is made that the third transaction is defined (YES) so the transaction is redirected at 412.

At 414, the determination is made that the second transaction request is being converted or translated (YES), so at 422 the second transaction is converted to an appropriate format (or formats) the for the financial data store (or stores) handling the third transaction request. At 424 the third transaction request (or requests) is sent to the appropriate financial data store (or stores). At 426, a response is received. If there are multiple responses from multiple financial data stores, the responses are also correlated. If the response (or correlated responses) is to be translated or converted to another format, the response (or correlated responses) is converted at 426. At 428, the response (correlated responses or translated correlated responses) is sent to the requestor.

Described above are example embodiments. It is, of course, not possible to describe every conceivable combination of components or methodologies for purposes of describing the example embodiments, but one of ordinary skill in the art will recognize that many further combinations and permutations of the example embodiments are possible. Accordingly, it is intended to embrace all such alterations, modifications and variations that fall within the spirit and scope of any claims filed in applications claiming priority hereto interpreted in accordance with the breadth to which they are fairly, legally and equitably entitled.

1. An apparatus, comprising:
an application program interface logic coupled with a self service device and a plurality of financial institution data stores;
wherein the application program interface logic is operable to receive transaction requests from the self service device;
wherein the application program interface logic is operable to selectively route a first transaction request to a first financial data store responsive to determining that the first transaction requests corresponds to a first type of transaction; and
wherein the application program interface logic is operable to selectively redirect a second transaction request to a second financial data store responsive to determining that the second transaction requests corresponds to a second type of transaction.

2. The apparatus set forth in claim 1, wherein the application program interface logic is operable to receive a response to the second transaction request from the second financial data store; and
wherein the application program interface logic is operable to route the response to the second transaction request to the self service device.

3. The apparatus set forth in claim 2, wherein the application program interface logic is operable to receive a response to the first transaction request from the first financial data store; and
wherein the application program interface logic is operable to route the response to the first transaction to the self service device.

4. The apparatus set forth in claim 1, wherein the application program interface logic is coupled with a transaction processor; and
wherein the application program interface logic is operable to forward a third transaction request that is to be handled by the transaction processor to the transaction processor.

5. The apparatus set forth in claim 1, wherein the application program interface logic comprises a library of application program interface hooks specifying types and formats of data that can be pushed or pulled by the application program interface logic.

6. The apparatus set forth in claim 5, wherein the application program interface logic translates the second request to a format that is compatible with the second financial data store.

7. The apparatus set forth in claim 6, wherein the application program interface logic translates a response to the second request to a format that is compatible with a screen associated with the second request at the self service device.

8. The apparatus set forth in claim 1, wherein the application program interface logic is coupled with a plurality of self service devices; and
wherein the application program interface logic is operable to receive transaction requests from the plurality of self service devices.

9. The apparatus set forth in claim 7, wherein the application program interface logic is operable to maintain a plurality of libraries corresponding to the plurality of self service devices.

10. The apparatus set forth in claim 1, wherein the application program interface logic is operable to reject a third transaction request responsive to determining that the application program interface logic does not have predefined data indicating how to handle the third transaction request.

11. Logic encoded in a non-transitory, tangible computer readable medium of execution for execution by a processor, and when executed operable to:
receive transaction requests from a self service device;
determine a type of transaction for the transaction requests;
route a first transaction requests unchanged to a first financial data store responsive to determining that the first transaction requests corresponds to a first type of transaction; and
re-format a second transaction request to a format compatible with a second financial data store and forward the re-formatted, second transaction request to the second data store responsive to determining the second transaction request corresponds to a second type of transaction.

12. The logic set forth in claim 11, the logic is further operable to:
receive a response to the second transaction request; and
re-format the response to the second transaction request to a pre-defined format for the self service device and forward the re-formatted response to the second transaction request to the self service device.

13. The logic set forth in claim 11, the logic is further operable to:
receive a response to the first transaction request; and
forward the response to the first request unchanged to the self service device.

14. The logic set forth in claim 11, wherein the first destination is coupled with a transaction processor; and
wherein the logic is further operable to forward transaction requests for the first type of transaction to the transaction processor.

15. The logic set forth in claim 11, wherein the logic comprises a library of application program interface hooks specifying types and formats of data that can be pushed or pulled by the logic.

16. The logic set forth in claim 11, wherein the logic is coupled with a plurality of self service devices; and
wherein the logic is further operable to receive a plurality of transaction requests from the plurality of self service devices.

17. The logic set forth in claim 16, wherein logic is operable to maintain a plurality of libraries corresponding to the plurality of self service devices coupled with the first interface.

18. The logic set forth in claim 11, wherein logic is further operable to reject a third transaction request responsive to determining that the logic does not have predefined data indicating how to handle the third type of transaction.

19. The logic set forth in claim 10, wherein logic is further operable to:
send a plurality of requests for the second transaction request to a plurality of financial data stores;
receive responses from the plurality of financial data stores for the second transaction type;
correlate the responses from the plurality of financial data stores for the second transaction type;
format the correlated responses from the plurality of data stores for the second transaction type to a predefined format for the self service device; and
forward the formatted, correlated responses from the plurality of financial data stores for the second transaction type to the self service device.

20. A method, comprising:
receiving a first transaction request of a first transaction type from a self service device;
receiving a second transaction request of a second transaction type from a self service device;
determining where to route the first transaction request based on the first transaction type;
determining where to route the second transaction request based on the second transaction type;
routing the first transaction requests to a first financial data store responsive to determining the first transaction request corresponds to the first type of transaction; and
forwarding the second transaction request to a second financial data store responsive to determining the second transaction request corresponds to the second type of transaction.

21. The method of claim 19, further comprising:
receiving a response to the second transaction request;
determining a pre-defined data format for the response to the second transaction for the self service device;
formatting the response to the second transaction request to the pre-defined format for the self service device; and
forwarding the formatted response to the second transaction request to the self service device.
